(19) United States
(12) Patent Application Publication
(10) Pub. No.: US 2007/0127317 A1
(43) Pub. Date: Jun. 7, 2007

(54) Recording alarm clock for special occasions

(76) Inventor: Leonard Chattle, Santee, CA (US)

Correspondence Address: JAMES RAY & ASSOCIATES, 2640 PITCAIRN ROAD, MONROEVILLE, PA, 15146, US

(21) Appl. No.: 11/595,215

(22) Filed: Nov. 9, 2006

Related U.S. Application Data
(60) Provisional application No. 60/742,652, filed on Dec. 6, 2005.

(51) Int. Cl. G04C 21/00

(52) U.S. Cl. 368/73

(57) ABSTRACT

An apparatus for reminding individuals of preselected important times and dates such individuals wish to remember. The apparatus includes a housing member having each of a predetermined shape, a predetermined size and a predetermined color. There is an audio receiving and recording mechanism disposed within such housing member for both receiving and recording preselected messages therein. A speaker mechanism is also disposed within the housing member. Such speaker mechanism is connected to the audio receiving and recording mechanism for receiving such message recorded by the audio receiving and recording mechanism and delivering the message in an audible voice to an individual at an appropriate time. Further, the apparatus includes a clock mechanism disposed within such housing member and connected, to the audio receiving and recording mechanism for causing such audio receiving and recording mechanism to send such message to the speaker mechanism at such appropriate time.

### CROSS REFERENCE TO RELATED APPLICATION

This patent application is related to and claims priority from U.S. Provisional Patent Application Ser. No. 60/742,652 filed Dec. 5, 2005.

### FIELD OF THE INVENTION

The present invention relates, in general, to alarm clocks and, more particularly, this invention relates to an alarm clock capable of recording predetermined messages for any occasion and/or purpose.

### BACKGROUND OF THE INVENTION

Prior to the conception and development of the present invention, as is well known in the art, alarm clocks and recording devices have been in widespread use. Alarm clocks are routinely used to tell time and/or to wake someone up at a desired preset time. Audio type recording devices are most commonly used to record preselected items such as, for example, messages and songs.

It is equally well recognized that due to today's hectic lifestyles many people will oftentimes forget certain important dates such as, for example, birthdays, anniversaries, meetings and other important occasions. Normally these dates are written on a calendar or an appointment book which may or may not be closely watched and these important dates may then be overlooked.

When certain significant dates are overlooked they may cause undue stress and/or friction between the individuals involved such as husbands and wives. It is also quite important to remember certain critical meetings related to work in order to avoid losing an important order or project.

### SUMMARY OF THE INVENTION

The present invention provides an apparatus for reminding individuals of certain preselected important times and dates such individuals need to remember. The invented apparatus includes a housing member having each of a predetermined shape, a predetermined size and a predetermined color. The housing member is formed from a predetermined material. There is an audio receiving and recording mechanism disposed within such housing member for both receiving and recording preselected messages therein. A speaker mechanism is also disposed within the housing member. Such speaker mechanism is connected to the audio receiving and recording mechanism for receiving such message recorded by the audio receiving and recording mechanism and delivering the message in an audible voice to an individual at an appropriate time. Further, the apparatus includes a clock mechanism disposed within such housing member and connected to the audio receiving and recording mechanism for causing such audio receiving and recording mechanism to send such message to the speaker mechanism at such appropriate time.

### OBJECTS OF THE INVENTION

It is, therefore, one of the primary objects of the present invention to provide an alarm clock which can record personalized messages as desired for any occasion.

Another object of the present invention is to provide an alarm clock which can record personalized messages that can be battery operated or electrically operated.

Still another object of the present invention is to provide an alarm clock which can record personalized messages that is relatively easy to use.

Yet another object of the present invention is to provide an alarm clock which can record personalized messages that can have any desired exterior design.

An additional object of the present invention is to provide an alarm clock which can record personalized messages wherein the case for such alarm clock can be made from a variety of different materials and in any desired color as well as in any predetermined desired shape.

A still further object of the present invention is to provide an alarm clock which can record personalized messages that can utilize wireless technology between the alarm clock and the recording device.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a schematic illustration of the various components of the present invention; and

FIG. 2 is a representative illustration of the apparatus of the present invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

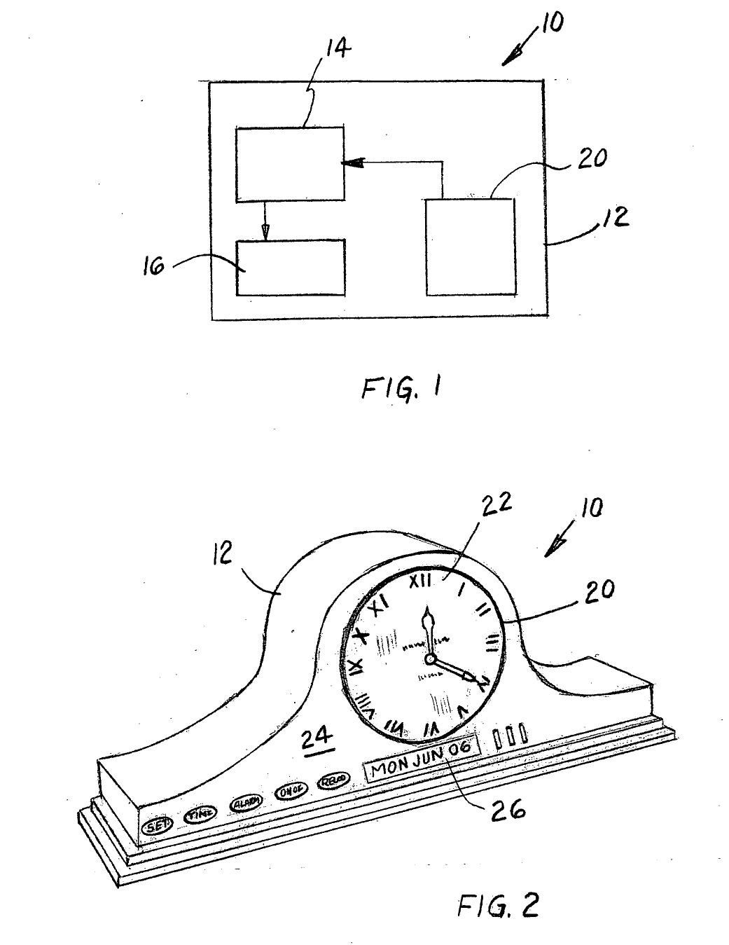

Now reference is made, more particularly, to FIGS. 1-2 of the drawings. Illustrated therein is an apparatus, generally designated 10 for reminding individuals of certain preselected important times and dates such individuals need to remember. In the presently preferred embodiment of the invention such certain preselected important times and dates include at least one of birthdays, anniversaries, weddings, doctors appointments, work appointments, vacation times and other special events.

According to the present invention such apparatus 10 includes a housing member 12 having each of a predetermined shape, a predetermined size and a predetermined color. The housing member 12 being formed from a predetermined material.

Additionally, the predetermined material such housing member 12 is formed from may be selected from the group consisting of plastic, ceramic, wood and metal. It is presently preferred for such housing member 12 to be formed from a plastic material for both cost considerations and ease of forming the selected predetermined shape of such housing member 12.

The selected predetermined shapes of housing member 12 will normally be selected from the group consisting of animals, ships, preselected automobiles, airplanes, sports equipment and preselected geometric shapes.

When such animals are selected they will be selected from the group consisting of wild animals and tamed animals. Such wild animals will at least include elephants, lions, tigers, cheetahs, giraffes, leopards, zebras, monkeys and deer. Tamed animals will preferably be selected from horses, dogs, cats and rabbits.

If the predetermined shape of such housing member 12 is an automobile it will, preferably, be selected from one of an antique automobile and a race car. Further, If the predetermined shape of such housing member 12 is selected from sports equipment it will be selected from one of football, baseball, basketball, soccer, hockey, volleyball, lacrosse and golf type equipment. On the other hand, if the predetermined shape of such housing member 12 is selected from a preselected geometric shape such geometric shape will include round, oblong, rectangular, pentagonal, hexagonal and octagonal.

Apparatus 10 also includes an audio recording mechanism 14 disposed within such housing member 12 for receiving and recording preselected messages therein. A speaker mechanism 16 is disposed within such housing member 12 and connected to the audio recording mechanism 14 for receiving such message recorded by such audio recording mechanism 14 and delivering that message in an audible voice to an individual at an appropriate time.

The final essential element of the apparatus 10 is a clock mechanism, generally designated 20, disposed within the housing member 12 and connected to such audio recording mechanism 14 for activating and causing such audio recording mechanism 14 to send the message to the speaker mechanism 16 at such appropriate time.

In the presently preferred embodiment of the invention, the clock mechanism 20 includes a face portion 22 disposed adjacent a front face 24 of such housing member 12. Additionally, such face portion 22 includes at least one of analog and digital features. Further, the clock mechanism 20 further includes an indicator 26 to exhibit at least one of time, month, day and year.

it is also presently preferred for the clock mechanism 20 to be an atomic clock capable of automatically setting and updating daily such at least one of time, month and day by a signal transmitted by satellite.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for reminding individuals of certain preselected important times and dates such individuals need to remember, said apparatus comprising:
(a) a housing member having each of a predetermined shape, a predetermined size and a predetermined color, said housing member being formed from a predetermined material;
(b) an audio recording mechanism disposed within said housing member for receiving and recording preselected messages therein;
(c) a speaker mechanism disposed within said housing member and connected to said audio recording mechanism for receiving said message recorded by said audio recording mechanism and delivering said message in an audible voice to an individual at an appropriate time; and
(d) a clock mechanism disposed within said housing member and connected to said audio recording mechanism for activating and causing said audio recording mechanism to send said message to said speaker mechanism at said appropriate time.

2. An apparatus, according to claim 1, wherein said certain preselected important times and dates include at least one of birthdays, anniversaries, weddings, doctors appointments, work appointments, vacation times and other special events.

3. An apparatus, according to claim 1, wherein said predetermined material said housing member is formed from is selected from the group consisting of plastic, ceramic, wood and metal.

4. An apparatus, according to claim 3, wherein said predetermined material said housing member is formed from is plastic.

5. An apparatus, according to claim 1, wherein said predetermined shape of said housing member is selected from animals, ships, preselected automobiles, airplanes, sports equipment and preselected geometric shapes.

6. An apparatus, according to claim 5, wherein said predetermined shape of said housing member is an animal selected from the group consisting of wild animals and tamed animals.

7. An apparatus, according to claim 5, wherein said predetermined shape of said housing member is one of an antique automobile and a race car.

8. An apparatus, according to claim 5, wherein said predetermined shape of said housing member is sports equipment selected from the group consisting of football, baseball, basketball, soccer, hockey, volleyball, lacrosse and golf.

9. An apparatus, according to claim 5, wherein said preselected geometric shapes include round, oblong, rectangular, pentagonal, hexagonal and octagonal.

10. An apparatus, according to claim 1, wherein said clock mechanism includes a face portion disposed adjacent a front face of said housing member.

11. An apparatus, according to claim 10, wherein said face portion includes at least one of analog and digital features.

12. An apparatus, according to claim 1, wherein said clock mechanism further includes an indicator to exhibit at least one of time, month, day and year.

13. An apparatus, according to claim 12, wherein said clock mechanism is an atomic clock capable of automatically setting and updating daily said at least one of time, month and day by a signal transmitted by satellite.
